(19) United States
(12) Patent Application Publication
(10) Pub. No.: US 2006/0064353 A1
(43) Pub. Date: Mar. 23, 2006

(54) Transaction method involving transfer of electronic files

(75) Inventor: Adam J. Kirkley, Suwanee, GA (US)

Correspondence Address: PAUL W. MARTIN, NCR CORPORATION, LAW DEPT., 1700 S. PATTERSON BLVD., DAYTON, OH, 45479-0001, US

(73) Assignee: NCR Corporation

(21) Appl. No.: 10/944,602

(22) Filed: Sep. 17, 2004

(51) Int. Cl. G06Q 30/00

(52) U.S. Cl. 705/26

(57) ABSTRACT

A transaction method involving transfer of electronic files to customer storage devices, which provides additional opportunities for retailers to sell electronic files. The transaction method includes recording selection by a customer of an electronic file for purchase, recording payment for the electronic file from the customer, and transferring the electronic file to a customer storage medium.

### BACKGROUND OF THE INVENTION

The present invention relates to checkout methods and more specifically to a transaction method involving transfer of electronic files.

Currently, retailers focus on selling electronic files, such as music and software files, via the World Wide Web. However, retailers are missing opportunities to sell electronic files in other ways.

Therefore, it would be desirable to provide a transaction method involving transfer of electronic files to a customer storage device.

### SUMMARY OF THE INVENTION

In accordance with the teachings of the present invention, a transaction method involving transfer of electronic files is provided.

The transaction method includes recording selection by a customer of an electronic file for purchase, recording payment for the electronic file from the customer, and transferring the electronic file to a customer storage medium.

It is accordingly an object of the present invention to provide a transaction method involving transfer of electronic files.

It is another object of the present invention to provide a method of providing electronic files, such as music and software, to customers from a self-service terminal.

### BRIEF DESCRIPTION OF THE DRAWINGS

Additional benefits and advantages of the present invention will become apparent to those skilled in the art to which this invention relates from the subsequent description of embodiments and the appended claims, taken in conjunction with the accompanying drawings, in which:

FIG. 1 is a block diagram illustrating a transaction system; and

FIG. 2 is a flow diagram illustrating operation of transaction software of the transaction system.

### DETAILED DESCRIPTION

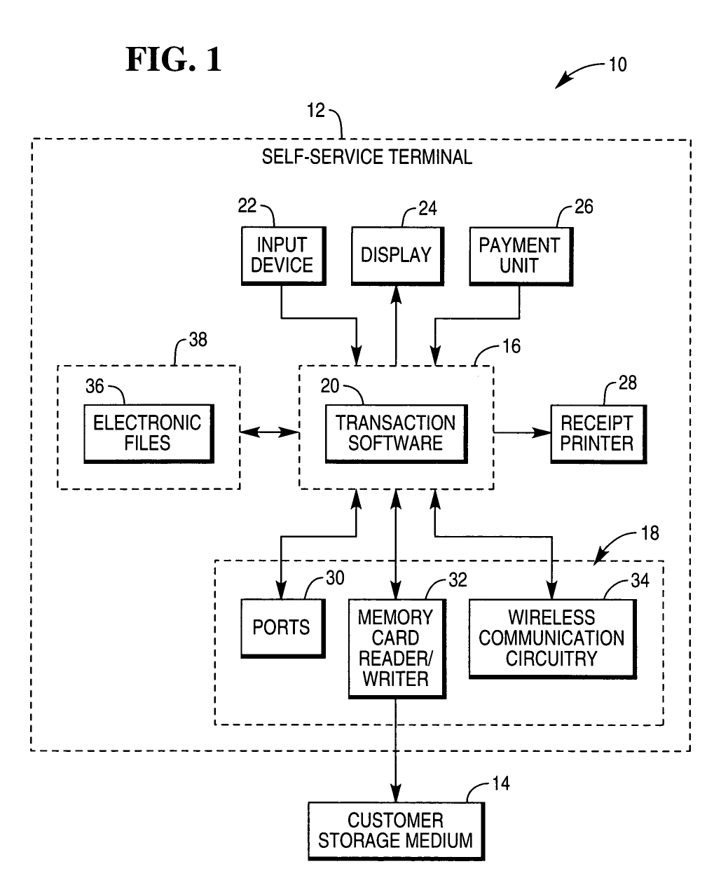

Referring now to FIG. 1, transaction system 10 includes self-service terminal 12 and customer storage medium 14.

Self-service terminal 12 includes processor 16, which executes transaction software 20. Transaction software 20 provides an interface for facilitating display, selection, and purchase of products by a user of self-service terminal 12. Products include electronic files 36 such as music and software. For this purpose, self-service terminal 12 may include a kiosk located at a retail establishment.

For example, music retailers may provide an audio file library that customers may browse with an option to purchase selected songs. As another example, software application providers may provide a software title library that customers may browse with an option to purchase software applications, including licenses to use downloadable copies of software applications.

Self-service terminal 12 further includes input device 22, display 24, payment unit 26, receipt printer 28, and storage medium 38.

Input device 22 records customer selections.

Display 24 displays products, product selection information, payment information, and information to assist the customer in using transaction terminal 12, all under the control of transaction software 20.

Payment device 26 may include a card reader, such as a smart, debit, or credit card reader. Payment unit 26 may also include a cash drawer or a cash acceptor and a cash dispenser, or a check reader.

Receipt printer 28 prints a receipt following a transaction.

Storage medium 38 stores electronic files 36.

In accordance with the present invention, self-service terminal 12 further includes electronic file transfer circuitry 18, which transfers purchased electronic files 36 to customer storage medium 14.

Electronic file transfer circuitry 18 may include ports 30, memory card reader/writer 32, and wireless communication circuitry 34.

Ports 30 may include universal serial bus (USB) ports, firewire ports, or any other standard port types.

Memory card reader/writer 32 reads memory cards insertable into customer storage medium 14.

Wireless communication circuitry 34 wirelessly downloads electronic files 36 to customer storage medium 14. Wireless communication circuitry 34 may include infrared circuitry, Bluetooth standard circuitry, or Blackberry standard circuitry.

Customer storage medium 14 stores electronic files 36 purchased by a customer using self-service terminal 12. Customer storage medium 14 is portable and may be owned by the customer. Customer storage medium 14 may include static storage, such as static read only memory (SRAM) or a small hard disk drive.

Customer storage medium 14 may be a stand-alone storage medium, such a USB storage medium, or be part of a customer peripheral, such as a cellular phone, personal digital assistant (PDA), MPEG-1 Audio Layer-3 (MP3) player, or laptop computer.

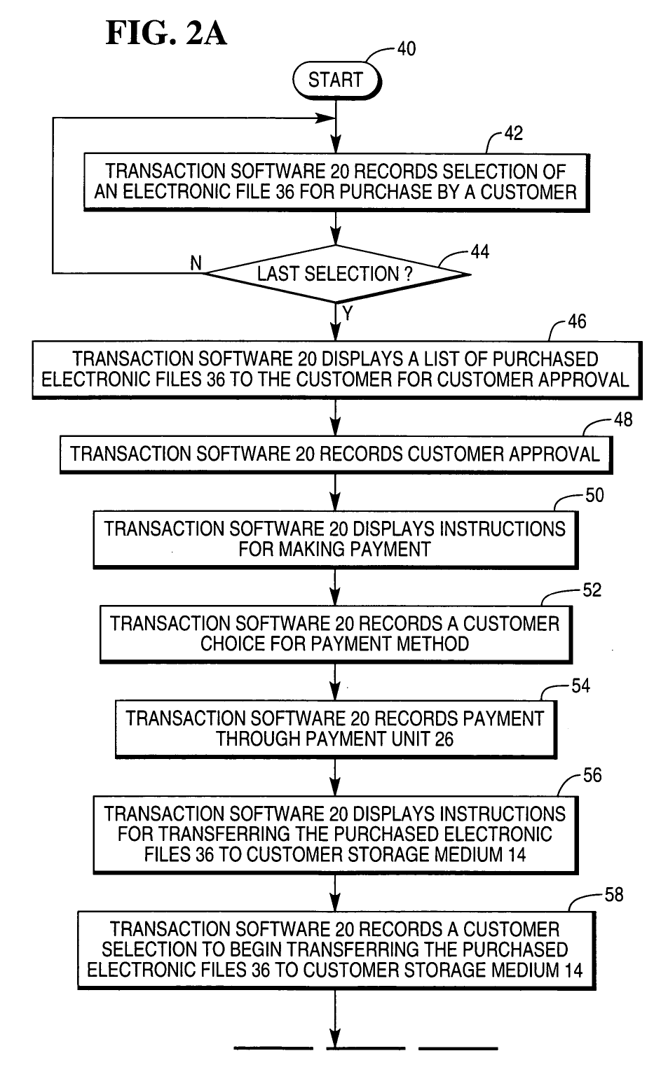

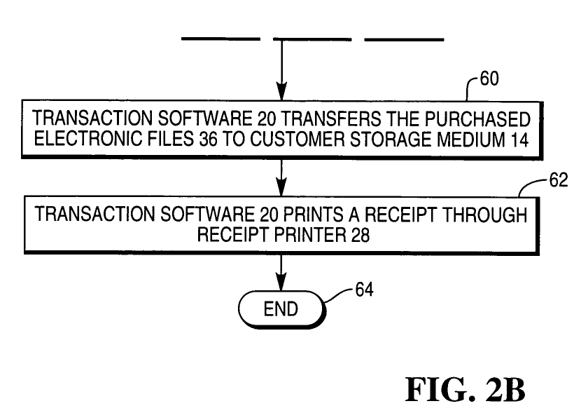

With reference to FIG. 2, operation of transaction software 20 is illustrated in detail, starting with Start 40.

In step 42, transaction software 20 records selection of an electronic file for purchase by a customer.

In step 44, transaction software 20 determines whether the selection is the last selection. Transaction software 20 may wait for the customer to select the “check out” option. If not, operation returns to step 42. Otherwise, operation proceeds to step 46.

In step 46, transaction software 20 displays a list of purchased electronic files 36 to the customer for customer approval.

In step 48, transaction software 20 records customer approval for the transaction.

In step 50, transaction software 20 displays instructions for making payment.

In step 52, transaction software 20 records a customer choice for payment method.

In step 54, transaction software 20 records payment through payment unit 26.

In step 56, transaction software 20 displays instructions for transferring the purchased electronic files 36 to customer storage medium 14. The customer prepares customer storage medium 14 for the transfer. Depending on the type of storage medium 14 or associated peripheral, the customer may connect customer storage medium 14 to one of ports 30, insert customer storage medium into memory card reader/writer 32, or initiate a wireless transfer.

In step 58, transaction software 20 records a customer selection to begin transferring the purchased electronic files 36 to customer storage medium 14.

In step 60, transaction software 20 transfers the purchased electronic files 36 to customer storage medium 14.

In step 62, transaction software 20 generates a receipt and optionally prints the receipt through receipt printer 28.

In step 64, operation ends.

Advantageously, retailers could make use of this solution to increase sales and reduce inventory at retail locations.

Although the invention has been described with particular reference to certain embodiments thereof, variations and modifications of the present invention can be effected within the spirit and scope of the following claims.

What is claimed is:

1. A transaction method comprising:
a) recording selection by a customer of an electronic file for purchase;
b) recording payment for the electronic file from the customer; and
c) transferring the electronic file to a customer storage medium.

2. The method of claim 1, wherein the electronic file is a music file.

3. The method of claim 1, wherein the electronic file is a software file.

4. The method of claim 1, wherein step b) comprises:
b-1) displaying a list including the electronic file to the customer for approval;
b-2) recording the approval of the customer;
b-3) recording a customer choice for a payment method; and
b-4) recording the payment through a payment unit.

5. The method of claim 1, wherein step c) comprises:
c-1) recording a customer selection to begin transferring the electronic file to the customer storage medium via a computer port.

6. The method of claim 1, wherein step c) comprises:
c-1) recording a customer selection to begin wirelessly transferring the electronic file to the customer storage medium.

7. The method of claim 1, wherein step c) comprises:
c-1) recording a customer selection to begin transferring the electronic file to the customer storage medium via a memory card reader/writer.

8. The method of claim 1, further comprising:
d) displaying a library of electronic files available for purchase including the one electronic file prior to step a).

9. The method of claim 8, wherein step d) comprises:
d-1) recording a customer selection to browse the library.

10. A transaction method comprising:
a) displaying a library of electronic files available for purchase;
b) recording selection by a customer of one of the electronic files;
c) displaying a list including the one electronic file to the customer for approval;
d) recording the approval of the customer;
e) recording a customer choice for a payment method;
f) recording the payment through a payment unit;
g) displaying instructions for transferring the electronic file to a customer storage medium;
h) recording a customer selection to begin transferring the electronic file to the customer storage medium;
i) transferring the electronic file to the customer storage medium; and
j) generating a receipt.

11. The method of claim 10, wherein step i) comprises:
h-1) transferring the electronic file to the customer storage medium via a computer port.

12. The method of claim 10, wherein step i) comprises:
h-1) wirelessly transferring the electronic file to the customer storage medium.

13. The method of claim 10, wherein step i) comprises:
h-1) transferring the electronic file to the customer storage medium via a memory card reader/writer.

14. A transaction system comprising:
a storage medium for storing an electronic file for sale;
a payment unit for processing customer payment for the electronic file;
means for transferring the electronic file to a customer storage medium; and
a processor for controlling operation of the storage medium, the payment unit, and the transferring means.

15. The system of claim 14, wherein the transferring means comprises a communications port.

16. The system of claim 14, wherein the transferring means comprises wireless communications circuitry.

17. The system of claim 14, wherein the customer storage medium comprises a memory card and the transferring means comprises a memory card reader/writer.

18. A transaction system comprising:
a storage medium for storing an electronic file for sale;
a payment unit for processing customer payment for the electronic file;
means for transferring the electronic file to a customer storage medium; and
a processor for controlling operation of the storage medium, the payment unit, and the transferring means.

19. A self-service terminal comprising:
a library medium including an electronic file for sale;
a display;
an input device for recording selections of a customer;
a payment unit for processing customer payment for the electronic file;
means for transferring the electronic file to a customer storage medium; and
a processor for displaying contents of the library medium available for purchase including the electronic file, for recording customer selection of the electronic file for purchase, for recording the customer payment for the electronic file, and for transferring the electronic file from the library medium to the customer storage medium.
